(19) United States
(12) Patent Application Publication
(10) Pub. No.: US 2005/0063568 A1
(43) Pub. Date: Mar. 24, 2005

(54) Robust face detection algorithm for real-time video sequence

(76) Inventors: Shih-Ching Sun, Jhubei City (TW); Mei-Juan Chen, Hualien City (TW)

Correspondence Address: J.C. Patents, Inc.;Suite 250, 4 Venture, Irvine, CA, 92618, US

(21) Appl. No.: 10/671,271

(22) Filed: Sep. 24, 2003

(51) Int. Cl. G06K 9/00

(52) U.S. Cl. 382/117; 382/118

(57) ABSTRACT

The invention is directed to a face detection method. In the method, an image data in a YCbCr color space is received, wherein a Y component of the image data to analyze out a motion region and a CbCr component of the image to analyze out a skin color region. The motion region and the skin color region are combined to produce a face candidate. An eye detection process on the image is performed to detect out eye candidates. And then, an eye-pair verification process is performed to find an eye-pair candidate from the eye candidates, wherein the eye-pair candidate is also within a region of the face candidate.

### BACKGROUND OF THE INVENTION

1. Field of Invention

The present invention relates to image processing. More particularly, the present invention relates to a technology to detection of a face on an image.

2. Description of Related Art

In recent years, human face detection is becoming more and more popular. Automatically detecting human faces is becoming a very important task in various applications such as video surveillance, human computer interface, face recognition and face image database management. In face recognition application, the human face location must be known before the processing. Face tracking application also needs a predefined face location at first. In face image database management, the human faces must be discovered as fast as possible due to the large image database. Although numerous methods are currently used to perform the face detection, there are still many factors that make the face detection more difficult, such as scale, location, orientation (upright and rotation), occlusions, expression, wearing glasses and tilt. Various approaches of face detection are proposed in recent years, but rare of them take all the above factors into account. However, a face detection technique that can be used in any real time application needs to satisfy the above factors. Skin color has been widely used to speed up the face detection process. The false alarms of skin color are unavoidable. Neural networks have also been proposed for detecting faces in gray images. However, the computational complexity is very high because neural networks have to process many small local windows in the images.

For the conventional face detection algorithms, the face still cannot be correctly and rather real-time identified due to detection error and long computation time. A better algorithm to detect face is still under developed to have better efficiency to detect the face.

### SUMMARY OF THE INVENTION

The invention provides a face detection method, suitable for use in a video sequence. The face detection method of the invention can efficiently and fast detect the face, whereby in a motion image, the face can be real-time detected with greatly reduced error.

The invention provides a face detection method comprising receiving an image data in a YCbCr color space, wherein a Y component of the image data to analyze out a motion region and a CbCr component of the image to analyze out a skin color region. The motion region and the skin color region are combined to produce a face candidate. An eye detection process on the image is performed to detect out eye candidates. And then, an eye-pair verification process is performed to find an eye-pair candidate from the eye candidates, wherein the eye-pair candidate is also within a region of the face candidate.

In the foregoing face detection method, the step of using the Y component of the image data comprises performing a frame difference process on the image for the Y component, wherein an infinite impulse response type (IIR-type) filter is applied to enhance the frame difference, so as to compensate a drawback of the skin color region.

In the foregoing face detection method, the method further comprises a labeling process to label a face location, so as to eliminate the face candidate with a relatively smaller label value.

In the foregoing face detection method, the step of performing the eye detection process comprises checking an eye area, wherein a set of criteria is used including eliminating the eye area out of a range. Then, a rate of the sys area is checked, wherein a preliminary eye candidate with a long shape is eliminated. And then, a density regulation is checked, wherein each of the eye candidates has a minimal rectangle box to fit the eye candidate, and if the preliminary eye candidate has a small area but a large MRB, the preliminary eye candidate is eliminated.

In the foregoing face detection method, wherein the step of performing the eye-pair verification process comprises finding out a preliminary eye-pair candidate by considering an eye-pair slop within ±45°. Then, the preliminary eye-pair candidate is eliminated when eye areas of two eye candidate of the preliminary eye-pair candidate has a large ratio. A face polygon based on the preliminary eye-pair candidate is produced, and the preliminary eye-pair candidate is eliminated when the face polygon is out of a region of the face candidate. An luminance image in a pixel area is set, wherein the luminance image includes a middle area and two side areas. A difference between an averaged luminance value in the middle area and an averaged luminance value in the two side areas are computed and if the difference is with a predetermined range then the preliminary eye-pair candidate is the eye-pair candidate.

Alternatively, the invention provides a face detection method on an image, comprising: detecting a face candidate; performing an eye detection process on the image to detect out at least two eye candidates; and performing an eye-pair verification process, to find an eye-pair candidate from the eye candidates, wherein the eye pair candidate is also within a region of the face candidate.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a process flow diagram, schematically illustrating a face detection method according to a preferred embodiment of the invention.

FIG. 2 is a resulting picture, schematically illustrating results of the frame difference and the enhanced frame difference for comparison, according to the preferred embodiment of this invention.

FIG. 3 is a resulting picture, schematically illustrating results of face location.

FIG. 4 is a resulting picture, schematically illustrating results of morphological operation in different component of YCbCr color space.

FIG. 5 is a resulting picture, schematically illustrating results of face verification.

FIG. 6 is a resulting picture, schematically illustrating results of overlap decision.

FIG. 7 is a resulting picture, schematically illustrating results of experimental result of test QCIF sequence.

FIG. 8 is a resulting picture, schematically illustrating some face detection results of test CIF sequences.

### DESCRIPTION OF THE PREFERRED EMBODIMENTS

In the invention, a novel approach for robust face detection is proposed. The proposed face detection algorithm includes skin color segmentation, motion region segmentation and facial feature detection. The algorithm can detect a common interchange format (CIF) image which contains facial expression, face rotating, tilting and different face sizes in real time (30 frames per second). Skin color segmentation and motion region segmentation rapidly localize the face candidate. A robust eye detection algorithm is utilized to detect the eye region. Finally, eye pair validation will decide the validity of the face candidate. An embodiment is described as an example as follows:

The present invention discloses a fast algorithm of face detection based on color, motion and facial feature analysis. Firstly, a set of chrominance values are used to obtain the skin color region. Secondly, a novel method for segmenting the motion region by the enhanced frame difference is proposed. Then, the skin color region and the motion region are combined to locate the face candidates. A robust eye detection method is also proposed to detect the eyes in the detected face candidates region. Then, each eye pair is verified to decide the validity of the face candidate.

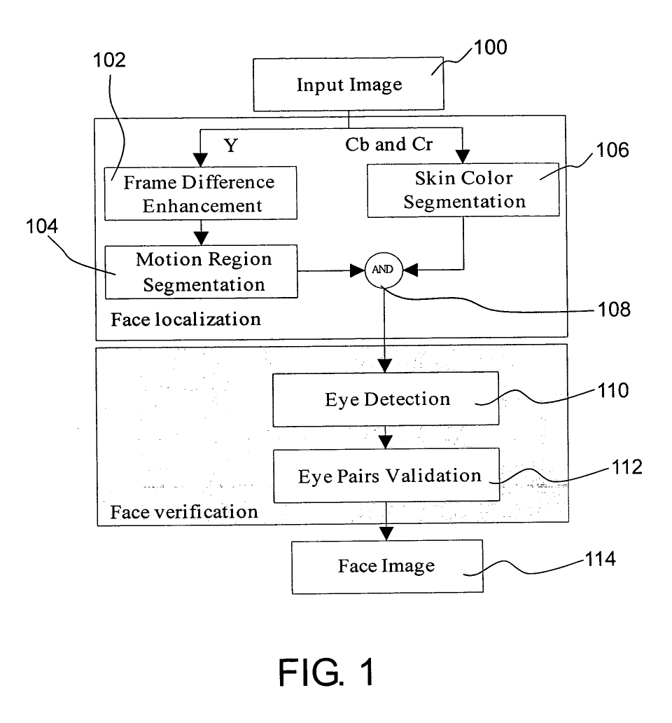

An overview of our face detection algorithm is depicted in FIG. 1, which contains two major modules: 1) face localization for finding face candidates and 2) facial feature detection for verifying the detected face candidates. Initially, the image data is received or input to the face location module at step 100. The image data is in a color space, such as a YCbCr color space. The image data can be divided into components, which are respectively sensitive to frame information and color information. In the YCbCr color space as the preferred color space, the Y component is sensitive to frame and the CbCr component is sensitive to color.

In step 102, the Y component is used to processed by a process of the frame difference enhancement. The frame difference is enhanced by Infinite Impulse Response type (IIR-type) filter and the motion region is segmented (step 104) by the proposed motion segmentation method. On the other hand, a general skin color model is used to partition pixels into skin pixels and non-skin pixels categories (step 106). Then, the motion region and the skin color region of the image are combined (step 108) to obtain more correct face candidates. Afterward, each face candidate is verified by eye detection 110 and eye pair validation 112. The region that passes the face verification successfully is reserved as the face area.

In more detail, the skin color segmentation is described as follows:

Modeling skin color requires choosing an appropriate color space and identifying a cluster associated with skin color in this space. The YCbCr color space is adopted since it is widely used in video compression standards (e.g., MPEG and JPEG). Moreover, the skin color region can be identified by the presence of a certain set of chrominance values (i.e. Cb and Cr) narrowly and consistently distributed in the YCbCr color space. The most suitable ranges for all the input images are R_{Cb}=[77, 127] and R_{Cr}=[133, 173]. A pixel is classified as a skin color pixel if both Cb and Cr values fall inside their respective range R_{Cb} and R_{Cr}.

The motion region segmentation is also described as follows in detail. Although skin color technique can locate the face region rapidly, it may detect false candidates in the background. We propose the motion region segmentation algorithm based on frame difference to compensate the drawback of only using skin color.

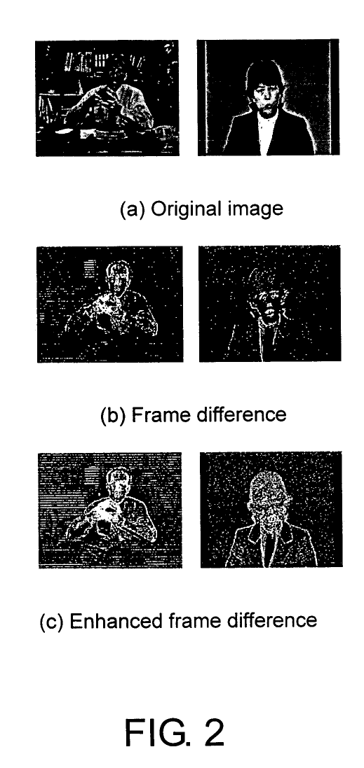

Frame difference is the efficient way to find the motion areas, but it has two serious defects. One is that the frame difference usually appears on the edge areas and the other one is that it sometimes becomes very weak when the object does not move much, as shown in FIG. 2(b). Therefore, the IIR-type filter is applied to enhance the frame difference. The concept of IIR filter is a feedback loop. Each output value is exported to the next input. For an M×N image, the proposed IIR-type is simplified and described as follows:
Oₜ(x,y)=1ₜ(x,y)+ω×Oₜ₋₁(x,y)
where x=0, . . . , M−1 and y=0, . . . , N −1, Iₜ(x,y) is original t-th frame difference and Oₜ(x,y) is the t-th enhanced frame difference at pixel (x,y). Here, ω is a weight which is set to be, i.e., 0.9. FIG. 2(c) shows the result of enhanced frame difference. It is obviously that motion regions become stronger than the original one and easier to be extracted.

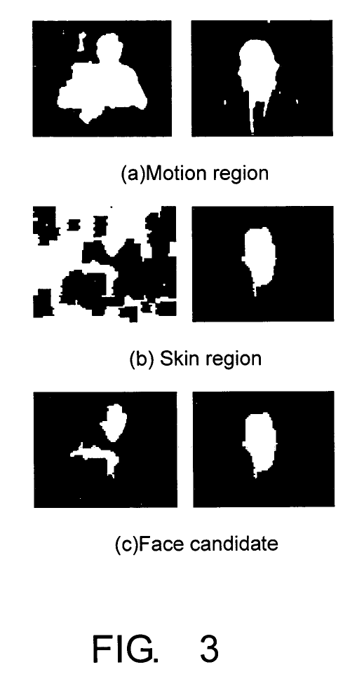

Mean filter and dilation operation are applied to eliminate noise and enhance the image. Hereby, a bitmap Oₜ(x,y) is obtained and each pixel with a value 1 means motion pixel and 0 means non-motion pixel. Then, the scanning procedure extracts the motion region. The scanning procedure is composed of two directions, which are vertical scan and horizontal scan, and are described as follows: In vertical scan, the top boundary and the bottom boundary of the motion pixel in each column of bitmap Oₜ(x,y) are searched out. Once these two boundaries have been found, each of the pixel between top boundary and the bottom boundary is set to be a motion pixel and assigned with the value of one. Else, the residual pixels outside these two boundaries are set to be non-motion pixel and assigned with the value of zero. Hence, a bitmap is obtained and denoted as O₂(x,y). The horizontal scan includes left-to-right scan and right-to-left scan. The left-to-right scan is described as follows:
O₂(x,y)=0, if (O₁(x,y)=0∩O₂(x−1,y)=0)
where x=1, . . . , M−1 and y=0, . . . , N−1. Then, the right-to-left scan is performed as:
O₂(x,y)=0, if (O₁(x,y)=0∩O₂(x+1,y)=0)
where x=M−2, . . . , 0 and y=0, . . . , N−1. If the pixel does not meet the criterion, the value of the pixel is not changed. Then, it is searched for any short continuous run of pixels that are assigned with the value of one in bitmap O₂(x,y) and subsequently removed. This is to ensure that a correct geometric shape of the motion region is obtained. FIG. 3(a) shows the result of motion region segmentation. The motion region is shown in white and non-motion region in black.

The skin color region, as shown in FIG. 3(b) and the motion region are combined to locate the face candidates. Then, the labeling technique is used to label face locations and eliminate small labels to acquire face candidates. FIG. 3(c) shows the face candidates after combining motion and skin color regions.

In the following descriptions, the eye detection 110 (see FIG. 1) is described in detail. It is intended to find the facial features to verify the existing of face. The idea is to detect each possible eye candidate in each face candidate. Then, the correlation of each pair of two eye candidates is considered and used to decide the validity of the face candidate.

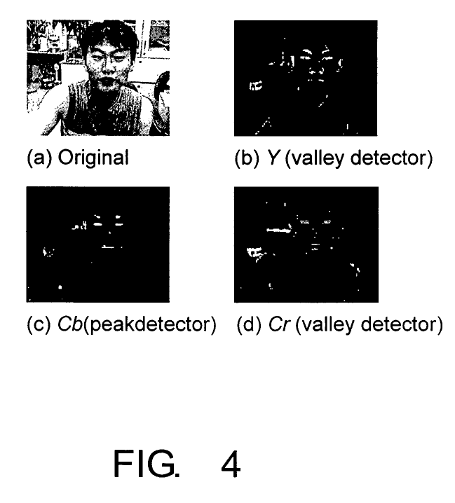

In the conventional algorithms, most of them detect the facial feature in the luminance component. However, under investigation of the invention, the luminance component always results in false alarm and noise. In fact, although the low intensity of the eye area can be detected by valley detector, the edge region has also lower intensity in the local region to be detected. Moreover, luminance component suffers from the light changing and shadow. In the invention, the eye is detected by chrominance component instead of luminance component. The analysis of the chrominance components indicates that high Cb values are found around the eye, under discover of the invention. So, the peak detector is preferably used to detect the high Cb value region. The peak fields of an image Cb(x,y) can be obtained as follows:
P(x,y)=}[(Cb²(x,y)⊖g(x,y)]⊕g(x,y)}−Cb²(x,y)
where g(x,y) is a structural element. The input Cb² image is eroded and then dilated before subtracted by itself. FIG. 4 shows the results of morphological operation in different components of YCbCr color space. It is obviously that Cb component has less and more compact eye candidates than Y and Cr components. In Y component, due to the brighter pixel around the eye region, the valley detector always results in shattered eye candidates, as shown in FIG. 4(b).

There are several criteria can be used to eliminate false eye candidates:

1. Eye area: Any eye candidate with too large or too small area will be eliminated.

2. Rate of eye area: An eye candidate with long shape will also be eliminated.

3. Density regulation: Each eye candidate has a Minimal Rectangle Box (MRB) to fit the eye candidate. If the eye candidate has a small area but a large MRB, it will be erased.

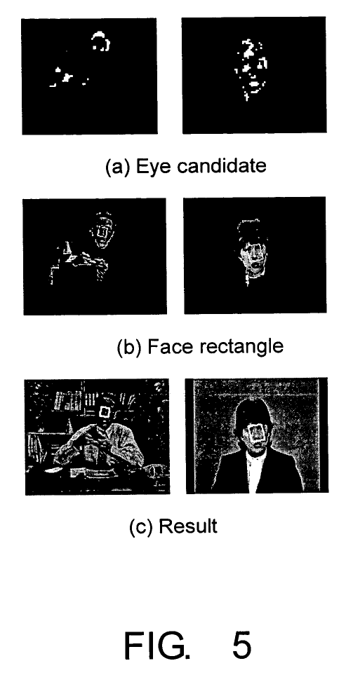

FIG. 5(a) shows the eye candidate image after the peak detection.

In the subsequent steps, each eye candidate pair are selected and be verified whether or not it is a correct eye pair. There are still several criteria to help us to find the correct eye pair candidate.

Any eye pair candidate will be regarded as correct eye pair if its slope is between ±45°.

Any eye pair candidate will be eliminated if the area ratio of two eyes is too large.

Each eye pair candidate will be extended to generate a face rectangle (FIG. 5(b)). If the face rectangle is within the face candidate, it will be regarded as a correct face rectangle.

According to the eye pair position, a luminance image, such as a size of 20×10 in pixels, are sampled. Then, it is calculated for the mean difference between center region and two side regions of the sampled image. The equation is described as follows:

$$Diff = \frac{{\sum }_{x = 6}^{13} {\sum }_{y = 0}^{9} Y ( x , y )}{80} - \frac{{\sum }_{x = 0}^{5} {\sum }_{y = 0}^{9} Y ( x , y ) + {\sum }_{x = 14}^{19} {\sum }_{y = 0}^{9} Y ( x , y )}{120}$$

A correct eye pair should have a higher mean difference because the eyes usually have low intensity. If the mean difference of the eye pair is between the predefined thresholds, Diffᵤₚ and Diff_{down}, it is regarded as a correct eye pair. The actual quantities of Diffᵤₚ and Diff_{down} are determined according to the actual design and the size of the luminance image. For example, Diffᵤₚ and Diff_{down} are 64 and 0.

Moreover, if the face rectangles (or square, or even polygon) are overlapped in a face candidate, the following criteria are used to decide the correct one. The number of edge pixel of the sampled eye image is calculated. Each sampled eye image obtains a number of edge pixels which was denoted as E. Then, it is calculated for the symmetry of the sampled eye image. Each sampled image obtains a symmetry value S:

$$S = ( {\sum }_{x = 0}^{9} {\sum }_{y = 0}^{9} Y ( x , y ) - Y ( 19 - x , y ) ) / ( {Y}_{max} - {Y}_{min} + 1 )$$

where Y is the luminance value and Yₘₐₓ and Yₘᵢₙ are the maximum and minimum luminance values in the sampled eye image, respectively. In general, a real eye image will have a high E value that is caused by facial feature and low S value. Then, the face score is calculated:

$$FaceScore = \frac{E}{S} .$$

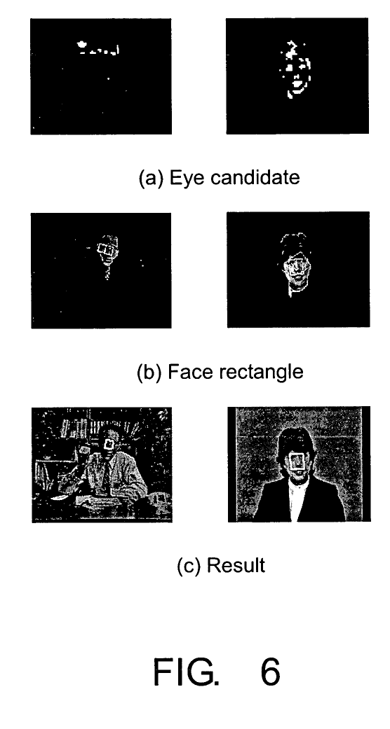

Then, the eye pair is regarded as a real eye pair if it has the largest FaceScore value and the corresponding face rectangle remains. FIG. 6(c) shows the results of overlap decision.
Experimental Results

In this section, the experiment results are shown. The experiment contains two sets, set 1 and set 2. In set 1, six QCIF video sequences which include four benchmarks and two video sequences have been tested. In set 2, 12 CIF sequences are recorded by web camera. The spatial sampling frequency ratio of Y, Cb and Cr is 4:2:0. N_{c}, Nₘ and N_{f} are used to indicate the number of face which are correctly detected, missed and falsely detected, respectively. The detection rate (DR) and false rate (FR) which are defined as follows:
DR=N_{c}/(N_{c}+Nₘ) FR=N_{f}/(N_{c}+N_{f})

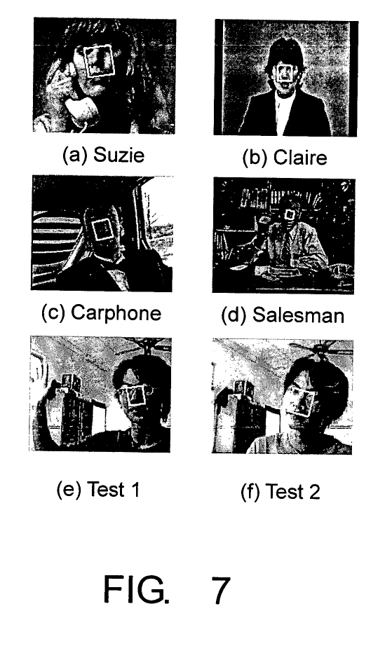

In the set 1, FIG. 7 shows the test QCIF video sequence which includes Suzie, Claire, Carphone, Salesman and two test sequences. The first 100 frames of each sequence have been tested and get the statistics. These sequences include various head poses such as raising, rotating, lowering, tilting and zooming. Because the head poses are various, a few error detections are detected in certain frames. Table 1 shows the detection rate of the selected benchmarks and video sequences. We can see that all of the detection rates are higher than 80%. The miss detected frames are usually caused by winking, disappeared eye or the eye cannot be separated from hair. In FIG. 7(e)(f), these two video sequences are recorded by web camera in difference lighting conditions. For QCIF sequences, the average detection time is 8.1 ms per frame at Pentium IV 2.4 GHz PC.

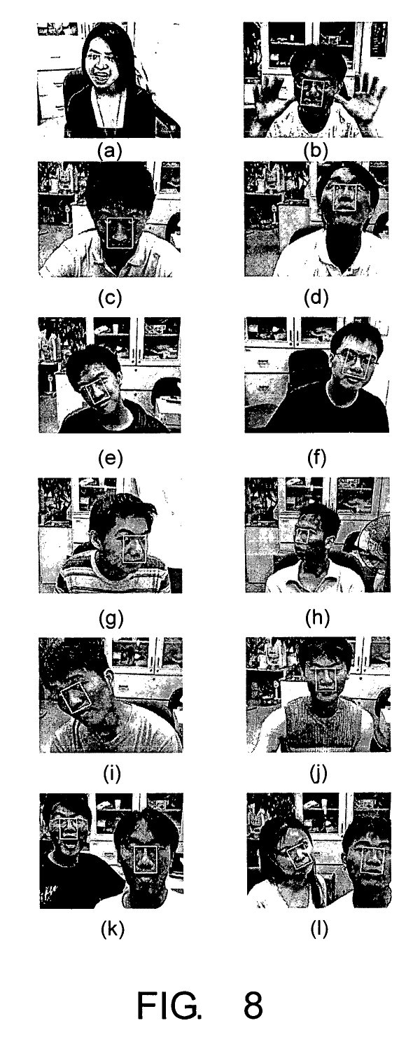

In the set 2, it is tested for 3500 video frames which contains 10 different persons. FIG. 8 shows some results of the test CIF video sequences and the detection rates are shown in Table 2. Each sequence contains various facial expression (FIG. 8(a)(b)) and head poses (FIG. 8(c)(d)(e)(f)), rotation (FIG. 8(g)(h)(i)) and multiple persons (FIG. 8(k)(1)). The average detection rate is 94.95% and the average false rate is 2.11%. Moreover, the average detection time of CIF video sequence is 32 ms per frame.

TABLE 1
Face detection results for QCIF sequences

| | DR | FR |
|---|---|---|
| Suzie | 91.0% | 4.2% |
| Claire | 86.0% | 9.5% |
| Carphone | 91.0% | 5.2% |
| Salesman | 86.0% | 1.1% |
| Test 1 | 93.0% | 5.1% |
| Test 2 | 80.0% | 14.0% |
| Average | 87.8% | 6.6% |

TABLE 2
Face detection results for
CIF sequences

| | DR | FR |
|---|---|---|
| (a) | 99.2% | 0.8% |
| (b) | 88.0% | 3.9% |
| (c) | 98.4% | 0.4% |
| (d) | 96.8% | 2.0% |
| (e) | 94.4% | 1.3% |
| (f) | 95.6% | 2.0% |
| (g) | 91.6% | 5.0% |
| (h) | 90.4% | 6.2% |
| (i) | 97.2% | 1.2% |
| (j) | 97.2% | 1.2% |
| (k) | 94.0% | 1.1% |
| (l) | 96.6% | 0.2% |

Average DR: 94.95%
Average FR: 2.11%

The proposed algorithm focuses on the research of real time face detection. Efficient motion region segmentation and eye detection method are proposed. From experiment results, the proposed face detection algorithm has high detection rate and fast detection speed. It also shows that our proposed face detection algorithm can be executed in real-time and uncontrolled environments. The failed detection only occurs in very few frames. Therefore, the proposed algorithm is robust, practical and effective.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A face detection method, suitable for use in a video sequence, comprising:
receiving an image data in a YCbCr color space;
using a Y component of the image data to analyze out a motion region;
using a CbCr component of the image to analyze out a skin color region;
combining the motion region and the skin color region to produce a face candidate;
performing an eye detection process on the image to detect out eye candidates; and
performing an eye-pair verification process, to find an eye-pair candidate from the eye candidates, wherein the eye-pair candidate is also within a region of the face candidate.

2. The face detection method of claim 1, in the step of using the CbCr component of the image, wherein a Cb value is between 77 and 127, and a Cr value is between 133 and 173.

3. The face detection method of claim 1, wherein the step of using the Y component of the image data comprises:
performing a frame difference process on the image for the Y component, wherein an infinite impulse response type (IIR-type) filter is applied to enhance the 20 frame difference, so as to compensate a drawback of the skin color region.

4. The face detection method of claim 1, further comprising a labeling process to label a face location, so as to eliminate the face candidate with a relatively smaller label value.

5. The face detection method of claim 1, wherein the step of performing the eye detection process comprises:
checking an eye area, wherein the eye area out of a range is eliminated;
checking a rate of the sys area, wherein a preliminary eye candidate with a long shape is eliminated; and
checking a density regulation, wherein each of the eye candidates has a minimal rectangle box to fit the eye candidate, and if the preliminary eye candidate has a small area but a large MRB, the preliminary eye candidate is eliminated.

6. The face detection method of claim 1, wherein the step of performing the eye-pair verification process comprises:
finding out a preliminary eye-pair candidate by considering an eye-pair slop within ±45°;
eliminating the preliminary eye-pair candidate when eye areas of two eye candidate of the preliminary eye-pair candidate has a large ratio;
producing a face polygon based on the preliminary eye-pair candidate, and eliminating the preliminary eye-pair candidate when the face polygon is out of a region of the face candidate; and
setting an luminance image in a pixel area, wherein the luminance image includes a middle area and two side areas, wherein a difference between an averaged luminance value in the middle area and an averaged luminance value in the two side areas are computed and if the difference is with a predetermined range then the preliminary eye-pair candidate is the eye-pair candidate.

7. The face detection method of claim 6, wherein after the eye-pair candidate is determined and when multiple face polygons are overlapped, a face symmetric verification is further performed.

8. The face detection method of claim 7, wherein the number E of edge pixels of an eye image of the eye-pair candidate is divided by a symmetrical difference S, so as to produce a face-score value, wherein one of the face polygons with the largest face-score value is the selected one.

9. The face detection method of claim 6, wherein the face polygon include a rectangle or a square.

10. The face detection method of claim 6, wherein the luminance image is a 20×10 image area in pixel unit.

11. The face detection method of claim 10, wherein the middle area is the middle 8 pixels along a long side.

12. The face detection method of claim 10, wherein the middle area is to reflect a region between two eyes.

13. A face detection method, comprising:
receiving an image data in a color space;
using a first color component of the image data to analyze out a motion region;
using a second color component of the image to analyze out a skin color region;
combining the motion region and the skin color region to produce a face candidate;
performing an eye detection process on the image to detect out eye candidates; and
performing an eye-pair verification process, to find an eye-pair candidate from the eye candidates, wherein the eye-pair candidate is also within a region of the face candidate.

14. A face detection method on an image, comprising:
detecting a face candidate;
performing an eye detection process on the image to detect out at least two eye candidates; and
performing an eye-pair verification process, to find an eye-pair candidate from the eye candidates, wherein the eye pair candidate is also within a region of the face candidate.

15. The face detection method of claim 14, wherein the step of performing the eye detection process comprises:
checking an eye area, wherein the eye area out of a range is eliminated;
checking a rate of the sys area, wherein a preliminary eye candidate with a long shape is eliminated; and
checking a density regulation, wherein each of the eye candidates has a minimal rectangle box to fit the eye candidate, and if the preliminary eye candidate has a small area but a large MRB, the preliminary eye candidate is eliminated.

16. The face detection method of claim 14, wherein the step of performing the eye-pair verification process comprises:
finding out a preliminary eye-pair candidate by considering an eye-pair slop within ±45°;
eliminating the preliminary eye-pair candidate when eye areas of two eye candidate of the preliminary eye-pair candidate has a large ratio;
producing a face polygon based on the preliminary eye-pair candidate, and eliminating the preliminary eye-pair candidate when the face polygon is out of a region of the face candidate; and
setting an luminance image in a pixel area, wherein the luminance image includes a middle area and two side areas, wherein a difference between an averaged luminance value in the middle area and an averaged luminance value in the two side areas are computed and if the difference is with a predetermined range then the preliminary eye-pair candidate is the eye-pair candidate.

17. The face detection method of claim 16, wherein after the eye-pair candidate is determined and when multiple face polygons are overlapped, a face symmetric verification is further performed.

18. The face detection method of claim 16, wherein the face polygon comprises a rectangle or a square.
